(19) United States
(12) Patent Application Publication
(10) Pub. No.: US 2012/0315425 A1
(43) Pub. Date: Dec. 13, 2012

(54) COMPOSITE MATERIAL FOR BATTERY CASE AND METHOD OF MANUFACTURING THE SAME

(75) Inventors: Jin Woo Kwak, Uiwang (KR); Kyong Hwa Song, Seoul (KR); Chi Hoon Choi, Suwon (KR)

(73) Assignee: HYUNDAI MOTOR COMPANY, Seoul (KR)

(21) Appl. No.: 13/226,774

(22) Filed: Sep. 7, 2011

(30) Foreign Application Priority Data
Jun. 13, 2011 (KR) 10-2011-0056704

(51) Int. Cl. B32B 3/10; H01M 2/02; B32B 9/04; B32B 37/14; B32B 38/10

(52) U.S. Cl. 428/54; 156/244.19; 428/411.1

(57) ABSTRACT

Provided is a composite material for a battery case and a method of manufacturing the same, in which a heat-dissipating layer, which is filled with a heat-dissipating filler, is interposed between layers to effectively dissipate heat generated in a battery through the heat-dissipating layer. As a result, the lifespan is increased and the stability of the battery package is ensured. Moreover, according to the present invention, a neat layer which is not filled with the heat-dissipating filler is interposed between the heat-dissipating layers, and thus it is possible to prevent deterioration in mechanical properties.

### CROSS-REFERENCE TO RELATED APPLICATION

This application claims under 35 U.S.C. §119(a) the benefit of Korean Patent Application No. 10-2011-0056704 filed Jun. 13, 2011, the entire contents of which are incorporated herein by reference.

### BACKGROUND

(a) Technical Field

The present invention relates to a composite material for a battery case and a method of manufacturing the same, which can increase the lifespan of the battery and ensure its stability.

(b) Background Art

Lithium secondary batteries may be classified, in relation to the types of external cases in which they are enclosed, into: (i) can-type secondary batteries, in which a metal can is used as a container and sealed by a welding process, and (ii) pouch-type secondary batteries, in which an electrode assembly (comprising two electrodes, a separator, and an electrolyte) is accommodated in a pouch formed from a film.

Due to their flexibility characteristics, the pouch-type lithium secondary batteries have been increasingly used for vehicle batteries. Since the pouch-type secondary battery (hereinafter referred to as “a pouch cell”) has a freely changing shape and is lightweight, it is useful as an electric vehicle battery, in which a plurality of cells are stacked together.

However, the electric vehicle battery generates heat during high speed charging, during high power output, and during repeated charging and discharging, and thus a local temperature difference or a thermal runaway phenomenon, which reduces the efficiency and stability of the battery, occurs in the battery. Therefore, the battery case of the pouch cell, when being used in an electric vehicle, needs to have heat dissipation characteristics that can dissipate heat generated in the battery to the outside efficiently.

Moreover, since the conventional battery case of the pouch cell is formed of a composite material having an aluminum case or a plastic substrate such as PC+ABS, PA, PP, etc., which is filled with a mineral filler, such as a flame-retardant filler, it has excellent properties such as flame retardancy, chemical resistance, and durability, but has no heat dissipation characteristics.

In addition, the heat conductivity of the conventional battery case may be improved by filling the battery case with the existing polymer-based heat-dissipating composite material to provide heat transfer paths. However, the mechanical properties such as strength are reduced when this solution is utilized.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a composite material for a battery case and a method of manufacturing the same, in which a heat-dissipating layer filled with a heat-dissipating filler, is interposed between layers such that heat generated in a battery is effectively and efficiently dissipated, thus increasing the lifespan and ensuring the stability of a battery package.

Moreover, the present invention provides a battery case and a method of manufacturing the same, in which a neat layer, which is not filled with a heat-dissipating filler, is interposed between one or more layers to prevent deterioration in mechanical properties, which is caused in an existing heat-dissipating composite material which is filled with the heat-dissipating filler.

In one aspect, the present invention provides a composite material for a battery case, which includes a structure in which a polymer-based heat-dissipating layer, which is filled with a heat-dissipating filler, and a polymer-based neat layer, which is not filled with the heat-dissipating filler, are arranged in an alternating pattern and integrated such that heat generated in a heat source is dissipated through the heat-dissipating layer.

In an illustrative embodiment, the heat-dissipating filler is oriented in a thickness direction to transfer the heat in a through-plane direction.

In another illustrative embodiment, the heat-dissipating layer and the neat layer are applicable to a battery case for fixing a pouch-type battery or a housing for fastening the battery case.

In still another illustrative embodiment, the heat-dissipating layer has a structure in which a filler filled portion, which is filled with the heat-dissipating filler, and a resin filled portion, which is not filled with the heat-dissipating filler, are arranged in an alternating pattern in a longitudinal direction.

In yet another illustrative embodiment, the filler filled portions are arranged in an alternating pattern with the neat layer interposed therebetween.

In another aspect, the present invention provides a method of manufacturing a composite material for a battery case, the method comprising the steps of: preparing a heat-dissipating layer by extruding a polymer resin, which is filled with a heat-dissipating filler, and a neat layer by extruding another polymer resin, which is not filled with the heat-dissipating filler; stacking the heat-dissipating layers and the neat layers in an alternating pattern; integrating the stacked heat-dissipating layers and neat layers by compression; and cutting the compressed heat-dissipating layers and neat layers into a predetermined thickness in a width direction by a mechanical cutting device or water jet cutting device, thus manufacturing the composite material. More specifically, the composite material is attached to a battery case for fixing a pouch-type battery or a housing for fastening the battery case such that heat generated in a heat source is dissipated through the heat-dissipating layers.

In an illustrative embodiment, the heat-dissipating filler is oriented on a polymer resin-based flat plate in an in-plane direction.

In another illustrative embodiment, the heat-dissipating layers and the neat layers are cut in a direction perpendicular to the extrusion direction thereof.

In still another illustrative embodiment, in the step of preparing the heat-dissipating layer and the neat layer, filler filled portions, which are filled with the heat-dissipating fillers, are arranged at regular intervals in a longitudinal direction, and the polymer resin is interposed between the filler filled portions.

Other aspects and illustrative embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view showing a composite material for a battery case in accordance with a first embodiment of the present invention;

FIGS. 2 to 5 are process diagrams showing a method of manufacturing the composite material of FIG. 1;

FIGS. 6 to 8 are process diagrams showing a method of manufacturing a composite material in accordance with a second embodiment of the present invention; and

FIGS. 9 and 10 are a plan view and a side view, viewed from A and B of FIG. 8.

Reference numerals set forth in the Drawings includes reference to the following elements as further discussed below:
10: heat-dissipating layer
11: neat layer
12: heat-dissipating filler
13: extruder
14: feeder
15: flat die
16: filler filled portion
17: resin filled portion
18: extrusion direction
19: cooling roller

It should be understood that the appended drawings are not necessarily to scale, presenting a somewhat simplified representation of various illustrative features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, both gasoline-powered and electric-powered vehicles.

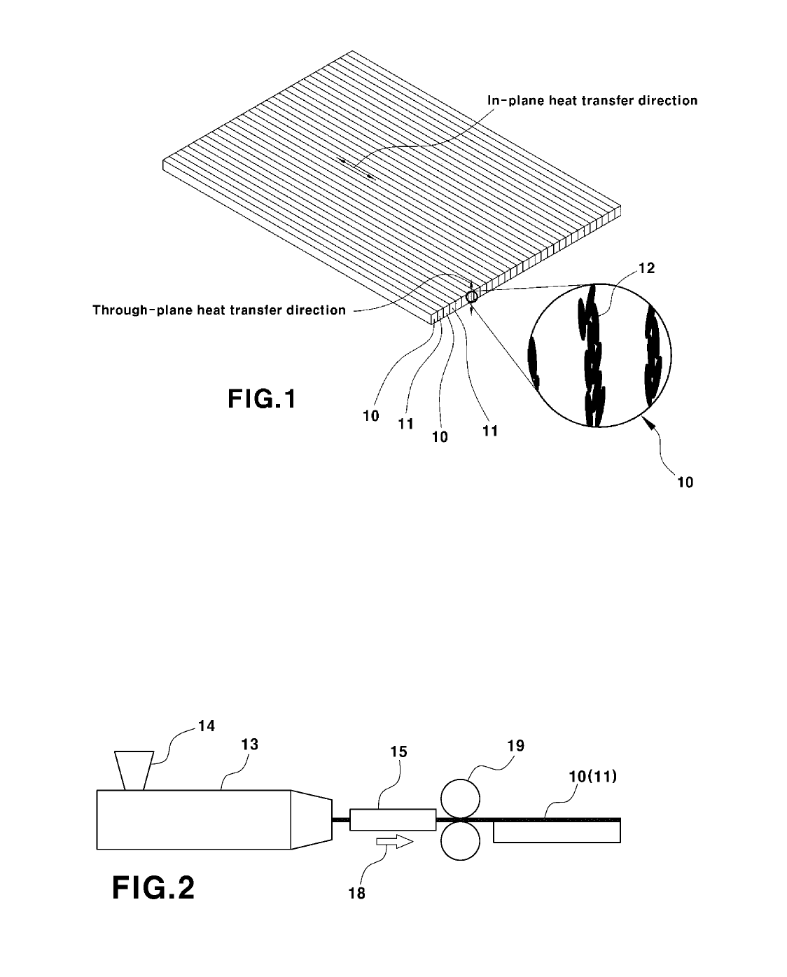

FIG. 1 is a perspective view showing a composite material for a battery case in accordance with a first embodiment of the present invention, and FIGS. 2 to 5 are process diagrams showing a method of manufacturing the composite material of FIG. 1.

The present invention provides a composite material for a battery case and a method of manufacturing the same, in which a neat layer 11, which is not filled with a filler, is disposed between heat dissipating layers by lamination to prevent deterioration in mechanical properties and, at the same time, improve heat conductivity. The composite material for a battery case in accordance with the first embodiment of the present invention has a flat, plate like structure and shape, in which a polymer-based heat-dissipating layer 10 and a neat layers 11 are arranged with each other in an alternating pattern as shown in FIG. 1.

Both of the heat-dissipating layer 10 and neat layer 11 are formed of a polymer-based material and have a flat structure in which the thickness is relatively small, e.g., several micrometers, and the length is greater than the width. The heat-dissipating layers 10 and the neat layers 11 having a flat structure in which the length is greater than the width are alternately stacked and connected together. Additionally, the connected heat-dissipating layers 10 and neat layers 11 are cut in a direction perpendicular to an extraction direction 18 indicated by an arrow of FIG. 2, thereby providing a composite material for a battery case with the flat structure.

Here, the heat-dissipating layer 10 is a polymer layer formed by filling a polymer-based flat plate with a heat-dissipating filler 12, and the neat layer 11 is a polymer layer with a polymer-based flat plate which is not filled with the heat-dissipating filler 12. For example, the heat-dissipating layer 10 and the neat layer 11 may be formed of a polycarbonate (PC) flat plate as the polymer-based flat plate and may have a thickness of about 10 to 30 μm, respectively.

Moreover, the heat-dissipating layer 10 may be formed by filling a plastic substrate such as polycarbonate flat plate with the heat-dissipating filler 12, for example, a ceramic filler in an amount of 80 wt % and orienting the heat-dissipating filler 12 in an in-plane direction on the plastic substrate.

The method of manufacturing the composite material for a battery case having the above-described structure in accordance with the first embodiment of the present invention will be described below.

As shown in FIG. 2, a polymer-based material such as polycarbonate powder and the heat-dissipating ceramic filler are fed into an extruder 13 through a feeder 14 and melted and extruded by the extruder 13 in the extrusion direction 18 indicated in FIG. 2, thus forming a heat-dissipating layer 10 in the form of a flat plate having a thickness of, e.g., about 10 to 30 μm. At this time, the polycarbonate resin discharged from the extruder 13 is molded in the form of a flat plate, having a predetermined thickness, by a flat die 15 and cooled by a cooling roller 19 to be laminated, thereby forming a final heat-dissipating layer 10.

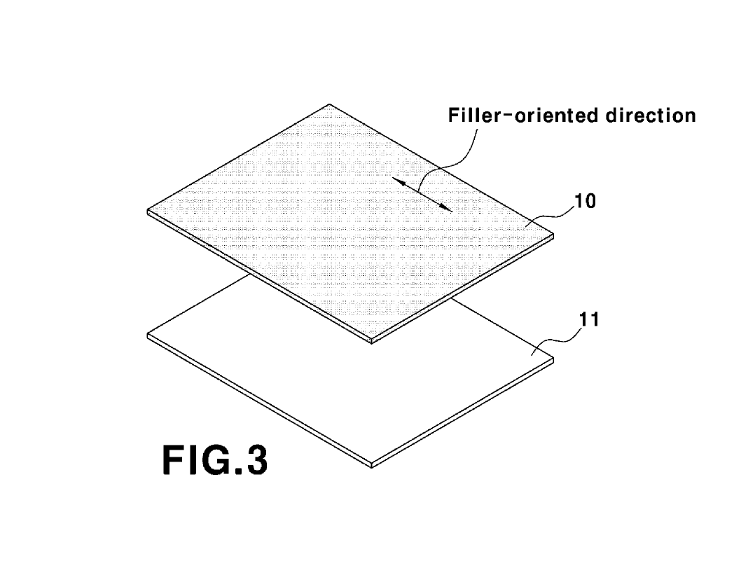

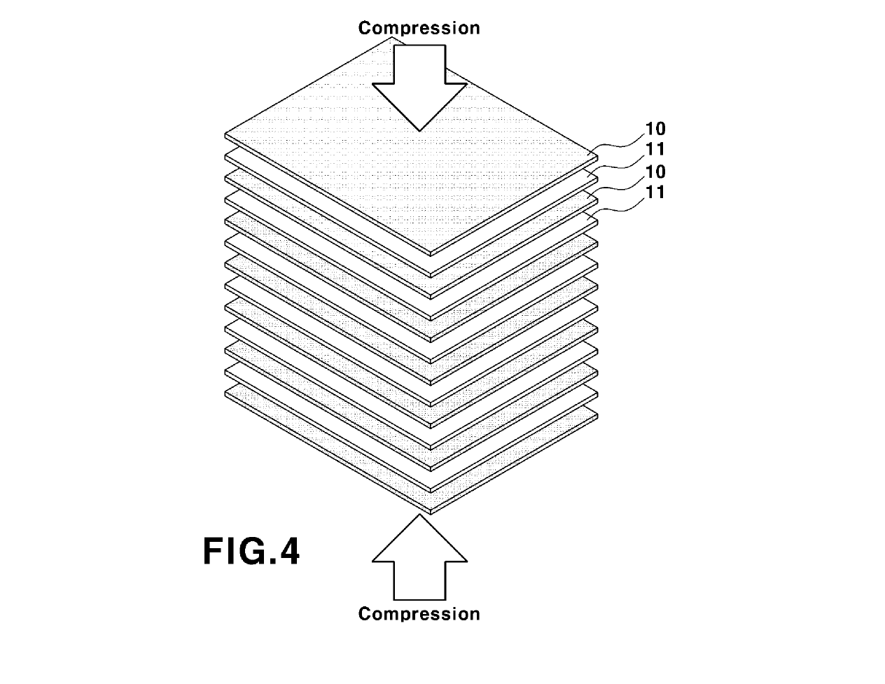

During the formation of the heat-dissipating layer 10 by the extrusion process, the ceramic filler in the amount of e.g., about 80 wt % is filled and, as shown in FIG. 3, oriented in the in-plane direction on the polycarbonate flat plate by the shear force. Moreover, as shown in FIG. 2, the polycarbonate powder is fed into the extrude 13 through the feeder 14 and melted and extruded by the extruder 13, thus molding a neat layer 11 in the form of a flat plate having a thickness of, e.g., about 10 to 30 μm.

Subsequently, the thus formed heat-dissipating layers 10 and neat layers 11 are stacked with each other in an alternating pattern, as shown in FIG. 4, and then passed through, e.g., an oven preheated at about 200° C. The stacked heat-dissipating layers 10 and neat layers 11 are compressed by a compressor at a pressure of about 10 tons to form a composite material having an overall thickness of, e.g., about 100 mm.

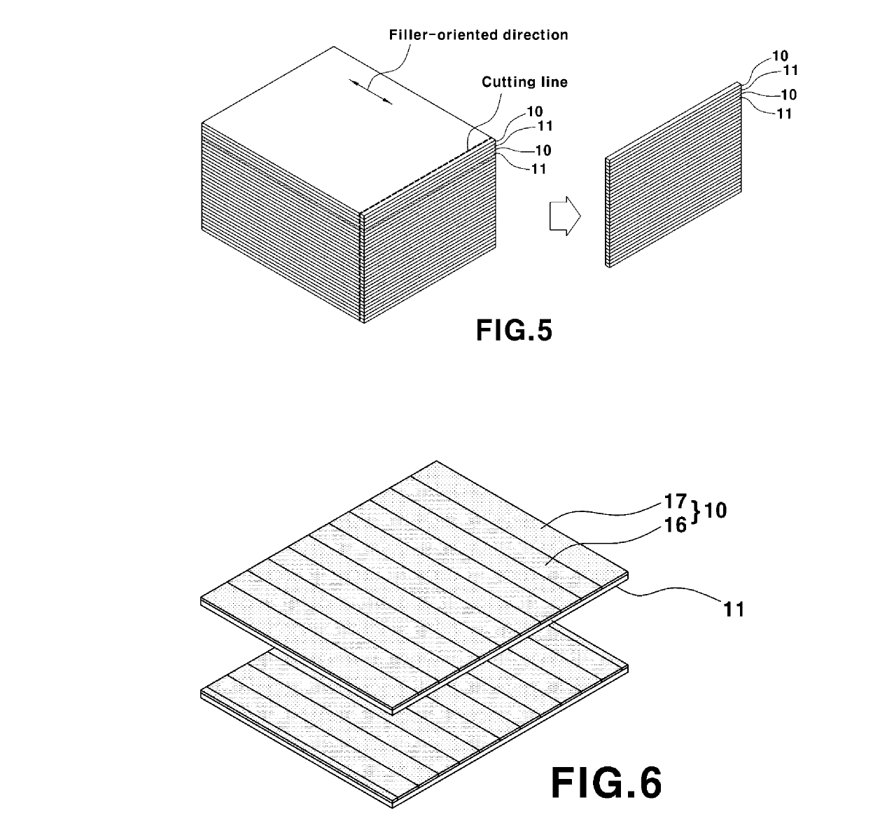

As shown in FIG. 5, the thus formed composite material includes thousands of heat-dissipating layers 10 and neat layers 11 stacked together. Continuously, the stacked composite material is cut in a direction perpendicular to the extrusion direction 18 of the heat-dissipating layers 10 and the neat layers 11 by a mechanical cutting device or water jet cutting device, thereby manufacturing a final composite material in the form of a flat plate having a thickness of, e.g., about 2 to 3 mm.

The composite material manufactured by the above method has a structure in which the heat-dissipating layers 10 and the neat layers 11 are arranged in an alternating pattern to be in continuous contact with each other in the width direction of the composite material. Therefore, when the composite material of the present invention is attached to a flat plate as a heat source, the heat generated from the heat source can be transferred in the in-plane direction (i.e., in the extrusion direction 18) as shown in FIG. 1 and can be efficiently and uniformly dissipated in the thickness direction with respect to the plane of the heat-dissipating layer 10 through the heat-dissipating filler 12 as shown in the enlarged view of FIG. 1.

Moreover, the neat layer 11 which is not filled with the heat-dissipating filler 12 is repeatedly disposed between the heat-dissipating layers 10 such that the amount of heat-dissipating filler used is reduced by at least 50% or more. As a result, it is possible to improve the cutting efficiency, compared to the flat plate prepared by filling the flat plate entirely with the heat-dissipating filler 12. Additionally, the present invention is able to further maximize the heat transfer characteristics due to high density of the fillers in the composite material.

While the heat-dissipating layer 10 and the neat layer 11 may have the same thickness ratio (1:1) as in the first embodiment, the present invention is not limited thereto, and the amount of heat-dissipating filler used in the composite material can be controlled by controlling the thickness of the neat layer 11.

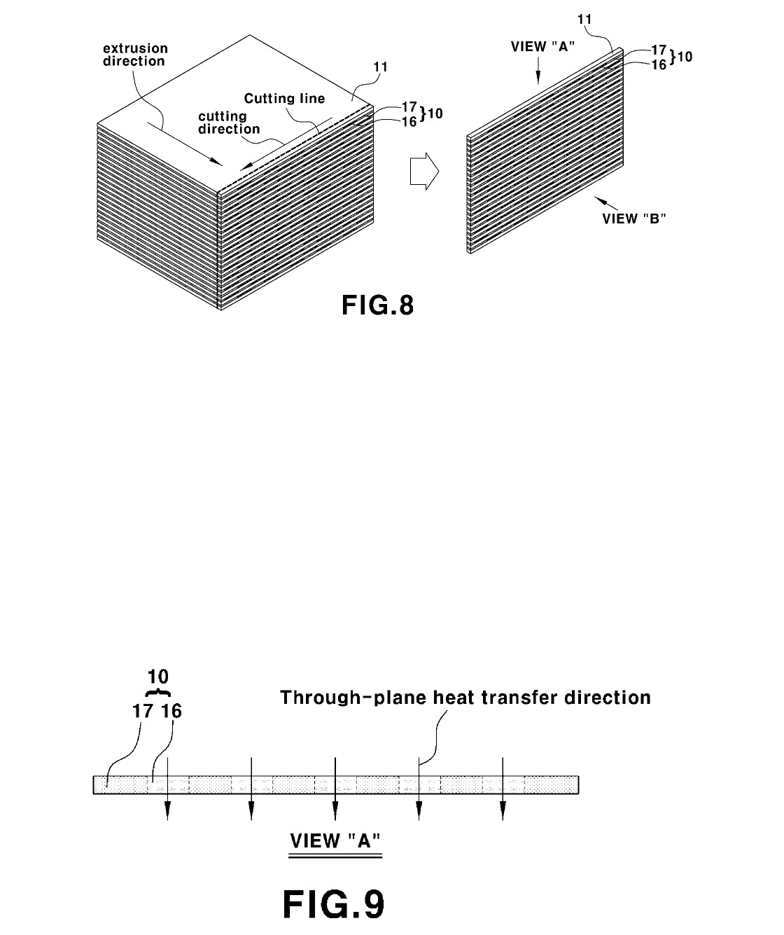

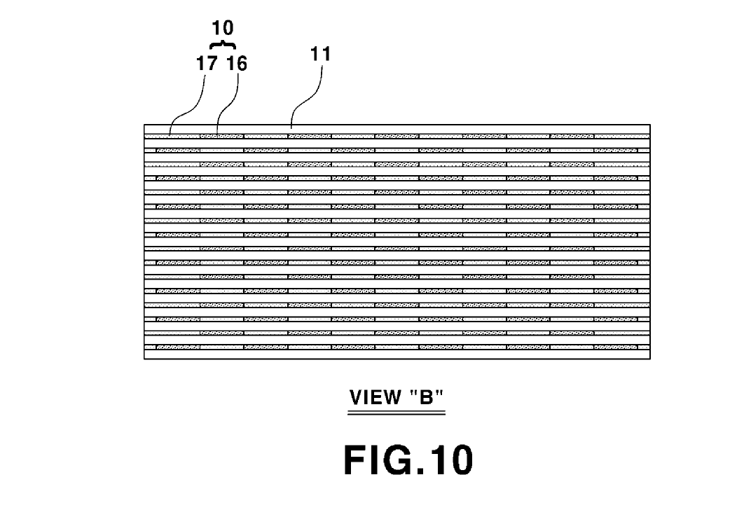

FIGS. 6 to 8 are process diagrams showing a method of manufacturing a composite material in accordance with a second embodiment of the present invention, and FIGS. 9 and 10 are a plan view and a side view, viewed from A and B of FIG. 8.

The composite material for a battery case in accordance with the second embodiment of the present invention has a structure in which the heat-dissipating layer 10 and the neat layer 11 are arranged with each other in an alternating pattern in an up and down direction, and the heat-dissipating layer 10 has a structure in which a filler filled portion 16 and a resin filled portion 17 are arranged in an alternating pattern to be in continuous contact with each other in the length direction of the composite material, thus maximizing the weight reduction effect.

As shown in FIG. 9A, the filler filled portions 16 are arranged in the alternating pattern with each other with the neat layer 11 interposed therebetween. As a result, it is possible to increase the weight reduction effect while maintaining the existing heat dissipation characteristics, compared to the existing heat-dissipating composite material obtained by entirely filling the heat-dissipating filler 12 without considering the directionality of the fill. As a result, the present invention is able to further achieve effective heat transfer characteristics in a specific direction.

Moreover, the filler filled portion 16 has a ribbon shape in which the length is greater than the width and may be formed of a polymer-based resin filled with the heat-dissipating filler 12 in an amount of 80 wt %, for example. Therefore, when the composite material of the present invention is attached to a flat plate as a heat source, the heat generated from the heat source can be effectively and uniformly dissipated to the outside through the fillers arranged in the thickness direction with respect to the plane of the heat-dissipating layer 10, as shown in FIG. 9. In particular, the resin filled portion 17 is disposed between the filler filled portions 16 to prevent delamination of the heat-dissipating layer 10.

The method of manufacturing the composite material for a battery case having the above-described structure in accordance with the second embodiment of the present invention will be described below.

As shown in FIG. 6, the filler filled portions 16 each having a ribbon shape (in the form of a flat plate having a length greater than the width and having a small thickness) and filled with the heat-dissipating filler 12 are arranged in parallel to each other at regular intervals in the longitudinal direction on the neat layer 11 which is not filled with the heat-dissipating filler 12, and the resin filled portions 17 (comprising a polymer resin) are disposed between the filler filled portions 16. Thus the delamination of the heat-dissipating layer 10 is prevented and the weight reduction effect is achieved.

Then, the neat layer 11 having the filler filled portion 16 is stacked on the top of each heat-dissipating layer 10 in an up and down direction in such a manner that the filler filled portions 16 adjacent in the up and down direction are arranged in an alternating pattern.

Subsequently, the stacked composite material is passed through an oven preheated at about 200° C., and the stacked heat-dissipating layers 10 and neat layers 11 are compressed by a compressor at a pressure of about 10 tons to form a composite material having an overall thickness of, e.g., about 100 mm.

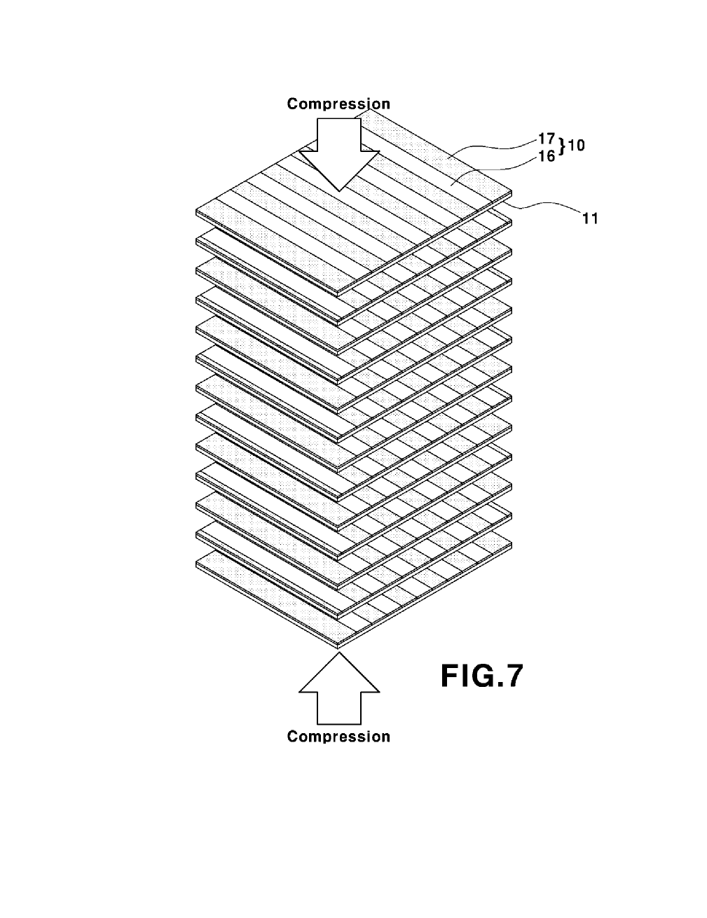

As shown in FIG. 7, the thus formed composite material may include thousands of heat-dissipating layers 10 and neat layers 11 stacked together. Continuously, as shown in FIG. 8, the stacked composite material is cut in a direction perpendicular to the extrusion direction 18 of the heat-dissipating layers 10 and the neat layers 11 by a mechanical cutting device or water jet cutting device, thereby manufacturing a final composite material in the form of a flat plate having a thickness of about 2 to 3 mm.

The polymer-based composite material manufactured by lamination in the above-described manner may be used as a battery case for fixing a pouch-type battery and as an upper cover and a lower cover (or a housing) for effectively fastening the battery cases and ensuring durability. Therefore, according to the present invention, the heat-dissipating layer 10 with the heat-dissipating filler 12 and the neat layer 11 without the heat-dissipating filler 12 are stacked in an alternating pattern such that the heat generated in the battery can be effectively dissipated, thereby ensuring the lifespan and stability of the high capacity battery pack for, e.g., an electric vehicle.

Moreover, the heat-dissipating layers 10 and the neat layers 11 stacked into thousands of layers are passed through the oven and then compressed by the compressor in the up and down directions, and the resulting heat-dissipating layers 10 and the neat layers 11 are cut in a direction perpendicular to the extrusion direction 18 of the heat-dissipating layers 10 and the neat layers 11. As a result, it is possible to improve the heat transfer characteristics and the heat conduction characteristics in a through-plane direction.

Furthermore, the neat layer 11 which is not filled with the heat-dissipating filler 12 is interposed between the heat-dissipating layers 10 to reduce the amount of filler used. Therefore, it is possible to prevent the deterioration in mechanical properties, caused by the existing heat-dissipating composite material prepared by entirely filling composite material with the heat-dissipating filler, thus improving the cutting efficiency. In addition, when the composite material of the present invention is attached to a flat plate as a heat source such as the battery case of an electric vehicle, the heat generated from the heat source can be effectively, efficiently and uniformly dissipated to the outside.

In the above description, the polymer resin according to the present invention has been exemplified as the polycarbonate, but the polymer resin may include thermoplastic resins, thermosetting resins, and thermoplastic elastomer resins.

Since the composite material in the form of a flat plate is formed by cutting the laminated heat-dissipating layers 10 and neat layers 11 in a direction perpendicular to the extrusion direction 18, it is possible to minimize the percolation inhibiting phenomena, which may occur when the filler filled in the extrusion direction is networked.

Compared to the composite material filled with the filler in an amount of 40 wt %, the directionality of the filler can be effectively controlled in accordance with the actual use environment of the composite material and, since the heat-dissipating filler 12 is repeatedly stacked between the layers, the effective heat transfer can be achieved by a high integration of the filler in the composite material layer.

Moreover, the composite material comprising a plurality of layers is manufactured by minimizing the thickness of two types of flat plates, and when the thus manufactured composite material is attached to a heat source such as the battery case, the heat generated from the heat source can be in uniform contact with the composite material and dissipated in the through-plane direction. As a result, it is possible to increase the weight reduction effect and achieve the effective heat transfer characteristics, compared to the conventional heat-dissipating composite material obtained by filling the composite material entirely with the heat-dissipating filler without considering the directionality.

As such, when the composite material according to the present invention is used, the weight reduction effect and effective heat transfer characteristics in a specific direction can be achieved, and thus it is possible to implement a compact and lightweight battery system having improved heat dissipation characteristics.

As described above, the composite material for the battery case and the method of manufacturing the same according to the present invention provide the following advantages:

1. The heat-dissipating layer with the heat-dissipating filler and the neat layer without the heat-dissipating filler are stacked in an alternating pattern, and thus it is possible to effectively dissipate the heat generated in the battery, thereby ensuring the lifespan and stability of the high capacity battery pack for an electric vehicle.

2. The heat-dissipating layers and the neat layers stacked into a plurality of layers are passed through an oven and compressed by a compressor in the upwards and downwards direction. Next, the compressed heat-dissipating layers and neat layers are cut in a direction perpendicular to the extrusion direction thereof. As a result, it is possible to improve the heat transfer characteristics and the heat conduction characteristics in a through-plane direction.

3. Since the neat layer which is not filled with the heat-dissipating filler is interposed between layers, it is possible to prevent the deterioration in mechanical properties, caused in the existing heat-dissipating composite material prepared by filling the entire composite material with the heat-dissipating filler, thus improving the cutting efficiency. Moreover, when the composite material of the present invention is attached to a flat plate as a heat source such as the battery case for an electric vehicle, the heat generated from the heat source can be effectively, efficiently and uniformly dissipated to the outside.

The invention has been described in detail with reference to illustrative embodiments thereof. However, it will be appreciated by those skilled in the art that changes may be made in these embodiments without departing from the principles and spirit of the invention, the scope of which is defined in the appended claims and their equivalents.

What is claimed is:

1. A composite material for a battery case, comprising
a structure in which a polymer-based heat-dissipating layer, which is filled with a heat-dissipating filler, and a polymer-based neat layer, which is not filled with the heat-dissipating filler, are arranged in an alternating pattern and integrated such heat generated in a heat source is dissipated through the heat-dissipating layer.

2. The composite material of claim 1, wherein the heat-dissipating filler is oriented in a direction in relation to the thickness of the heat-dissipating filler to transfer the heat in a through-plane direction.

3. The composite material of claim 1, wherein the heat-dissipating layer and the neat layer are used to form a battery case for fixing a pouch-type battery or a housing for fastening the battery case.

4. The composite material of claim 1, wherein the heat-dissipating layer has a structure in which a filler filled portion, which is filled with the heat-dissipating filler, and a resin filled portion, which is not filled with the heat-dissipating filler, are arranged in a alternating pattern in a longitudinal direction.

5. The composite material of claim 4, wherein the filler filled portions are arranged in an alternating pattern with the neat layer interposed therebetween.

6. A method comprising:
preparing a heat-dissipating layer by extruding a polymer resin, which is filled with a heat-dissipating filler, and a neat layer by extruding another polymer resin, which is not filled with the heat-dissipating filler;
stacking the heat-dissipating layers and the neat layers in an alternating pattern;
integrating the stacked heat-dissipating layers and neat layers by applying compression; and
cutting the compressed heat-dissipating layers and neat layers into a predetermined thickness in a width direction by a mechanical cutting device or water jet cutting device, thus manufacturing the composite material,
wherein the composite material comprising the heat-dissipating layers and the neat layers is attached to a battery case for fixing a pouch-type battery or a housing for fastening the battery case such that heat generated in a heat source is dissipated through the heat-dissipating layers.

7. The method of claim 6, wherein the heat-dissipating filler is oriented on a polymer resin-based flat plate in an in-planar direction.

8. The method of claim 6, wherein the heat-dissipating layers and the neat layers are cut in a direction perpendicular to the extrusion direction thereof.

9. The method of claim 6, wherein in the step of preparing the heat-dissipating layer and the neat layer, filler filled portions, which are filled with the heat-dissipating fillers, are arranged at regular intervals in a longitudinal direction, and the polymer resin is interposed between the filler filled portions.
